(19) United States
(12) Patent Application Publication
(10) Pub. No.: US 2026/0362472 A1
(43) Pub. Date: Nov. 12, 2026

(54) APPARATUS, METHOD, AND COMPUTER PROGRAM

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 19/099,178

(22) PCT Filed: Sep. 7, 2023
(86) PCT No.: PCT/EP2023/074523

§ 371 Date: Jan. 28, 2025

(30) Foreign Application Priority Data
Sep. 29, 2022 (GB) 2214303.6

(51) Int. Cl. H04W 74/00; H04W 56/00; H04W 74/0833

(52) U.S. Cl. CPC H04W 74/002; H04W 56/0045; H04W 74/0833

(57) ABSTRACT

There is provided a method, apparatus, and computer program for causing a user equipment to perform: receiving, from a first network node, a first information activating an identifier associated to a target network node; determining to transmit random access channel signalling using a configuration corresponding to the identifier associated to the target network node; and transmitting said random access channel signalling.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided a method for a user equipment, the method comprising: receiving, from a first network node, first information activating an identifier associated to a target network node; determining to transmit random access channel signalling using a configuration corresponding to the identifier associated to the target network node; and transmitting said random access channel signalling.

The determining may comprise: monitoring, for a first predetermined time period, for an instruction from the first network node to transmit random access channel signalling using the configuration corresponding to identifier associated to the target network node; and when no instruction is received during the first predetermined time period, determining to transmit said random access channel signalling using the configuration corresponding to the identifier associated to the target network node.

Said determining may comprise: determining, that uplink transmission timing for transmitting uplink transmission to the target network node is misaligned with respect to reception of uplink transmissions at the target network node; and determining to transmit said random access channel signalling using the configuration corresponding to the identifier associated to the target network node in response to determining said misalignment.

Said determining to transmit may be performed in response to determining that a timing alignment adjustment made by the user equipment cannot correct said misalignment.

Said receiving may comprise a handover command, and the determining may comprise: determining to transmit said random access channel signalling using the configuration corresponding to the identifier associated to the target network node in response determining that the handover command relates to a different physical cell identifier to the physical cell identifier associated to the first network node.

The method may comprise: receiving, from the target network node, a random access response to the random access channel signalling during a second predetermined time period; and using spatial information associated to the identifier associated to the target network node to configure uplink and/or downlink communications with the target network node in response to said received random access.

The method may comprise: monitoring for receipt of, from the target network node, a random access response to the random access channel signalling during a second predetermined time period; and subsequent to the expiry of said second predetermined time period without the random access response being received, using spatial information associated to the identifier associated to the target network node to configure uplink and/or downlink communications with the target network node.

The handover command may comprise a conditional handover command.

The determining may comprise: identifying that the identifier associated to the target network node has become activated by receiving spatial information and/or power control parameters associated to the identifier associated to the target network node.

The method may comprise: receiving the spatial information and/or power control parameters associated to the identifier associated to the target network node via at least one of a downlink control information, and/or a Medium Access Control Control Element, and/or a configuration for sounding reference signal signalling.

The method may comprise: identifying spatial information associated to the identifier associated to the target network node; and using said spatial information to configure uplink and/or downlink communications with the target network node.

The method may comprise: receiving, from at least one of the first and target network nodes, a calculated timing advance configuration to apply to transmissions made to the target network node; and transmitting to the target network node after applying the received calculated timing advance configuration.

The identifier associated to the target network node may comprise at least one of: a physical cell identity identifier, a Timing Advance Group identifier, control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a second aspect, there is provided a method for a system, the system comprising: a user equipment configured to perform the method according to any of the first aspect; the first network node; and the target network node, the method further comprising: receiving, at the target network node, the random access channel signalling from the user equipment subsequent to the user equipment receiving said first information activating the identifier associated to the target network node; calculating, at at least one of the first and target network nodes, a timing advance configuration to be applied by the user equipment to transmissions made by the user equipment to the target transmission reception point; and causing, by the at least one of the first and target network nodes, the calculated timing advance configuration to be signalled to the user equipment for altering a transmission time of transmissions made to the target transmission reception point.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a third aspect, there is provided an apparatus for a user equipment, the apparatus comprising means for: receiving, from a first network node and a target network node, first information activating an identifier associated to a target network node; determining to transmit random access channel signalling using a configuration corresponding to the identifier associated to the target network node; and transmitting said random access channel signalling.

The means for determining may comprise means for: monitoring, for a first predetermined time period, for an instruction from the first and/or target network node to transmit random access channel signalling using the configuration corresponding to identifier associated to the target network node; and when no instruction is received during the first predetermined time period, determining to transmit said random access channel signalling using the configuration corresponding to the identifier associated to the target network node.

Said means for determining may comprise means for: determining, that uplink transmission timing for transmitting uplink transmission to the target network node is misaligned with respect to reception of uplink transmissions at the target network node; and determining to transmit said random access channel signalling using the configuration corresponding to the identifier associated to the target network node in response to determining said misalignment.

Said means for determining to transmit may be performed in response to determining that a timing alignment adjustment made by the user equipment cannot correct said misalignment.

Said means for receiving may comprise means for receiving a handover command, and the means for determining may comprise means for: determining to transmit said random access channel signalling using the configuration corresponding to the identifier associated to the target network node in response determining that the handover command relates to a different physical cell identifier to the physical cell identifier associated to the first network node.

The apparatus may comprise means for: receiving, from the target network node, a random access response to the random access channel signalling during a second predetermined time period; and using spatial information associated to the identifier associated to the target network node to configure uplink and/or downlink communications with the target network node in response to said received random access.

The apparatus may comprise means for: monitoring for receipt of, from the target network node, a random access response to the random access channel signalling during a second predetermined time period; and subsequent to the expiry of said second predetermined time period without the random access response being received, using spatial information associated to the identifier associated to the target network node to configure uplink and/or downlink communications with the target network node.

The handover command may comprise a conditional handover command.

The means for determining may comprise means for: identifying that the identifier associated to the target network node has become activated by receiving spatial information and/or power control parameters associated to the identifier associated to the target network node.

The apparatus may comprise means for: receiving the spatial information and/or power control parameters associated to the identifier associated to the target network node via at least one of a downlink control information, and/or a Medium Access Control Control Element, and/or a configuration for sounding reference signal signalling.

The apparatus may comprise means for: identifying spatial information associated to the identifier associated to the target network node; and using said spatial information to configure uplink and/or downlink communications to the target network node.

The apparatus may comprise means for: receiving, from at least one of the first and target network nodes, a calculated timing advance configuration to apply to transmissions made to the target network node; and transmitting to the target network node after applying the received calculated timing advance configuration.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a fourth aspect, there is provided a system, the system comprising: a user equipment according to any of the third aspect; the first network node; and the target network node, wherein the target network node comprises means for the random access channel signalling from the user equipment subsequent to the user equipment receiving said first information activating the identifier associated to the target network node, at least one of the first and target network nodes comprises means for calculating a timing advance configuration to be applied by the user equipment to transmissions made by the user equipment to the target transmission reception point, and at least one of the first and target network nodes comprises means for causing the calculated timing advance configuration to be signalled to the user equipment for altering a transmission time of transmissions made to the target transmission reception point.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a fifth aspect, there is provided an apparatus for a user equipment, the apparatus comprising: at least one processor; and at least one memory comprising code that, when executed by the at least one processor, causes the apparatus to: receive, from a first network node, first information activating an identifier associated to a target network node; determine to transmit random access channel signalling using a configuration corresponding to the identifier associated to the target network node; and transmit said random access channel signalling.

The determining may comprise: monitoring, for a first predetermined time period, for an instruction from the first and/or target network node to transmit random access channel signalling using the configuration corresponding to identifier associated to the target network node; and when no instruction is received during the first predetermined time period, determining to transmit said random access channel signalling using the configuration corresponding to the identifier associated to the target network node.

Said determining may comprise: determining, that uplink transmission timing for transmitting uplink transmission to the target network node is misaligned with respect to reception of uplink transmissions at the target network node; and determining to transmit said random access channel signalling using the configuration corresponding to the identifier associated to the target network node in response to determining said misalignment.

Said determining to transmit may be performed in response to determining that a timing alignment adjustment made by the user equipment cannot correct said misalignment.

Said receiving may comprise receiving a handover command, and the determining may comprise: determining to transmit said random access channel signalling using the configuration corresponding to the identifier associated to the target network node in response determining that the handover command relates to a different physical cell identifier to the physical cell identifier associated to the first network node.

The apparatus may be caused to: receive, from the target network node, a random access response to the random access channel signalling during a second predetermined time period; and use spatial information associated to the identifier associated to the target network node to configure uplink and/or downlink communications with the target network node in response to said received random access.

The apparatus may be caused to: monitor for receipt of, from the target network node, a random access response to the random access channel signalling during a second predetermined time period; and subsequent to the expiry of said second predetermined time period without the random access response being received, use spatial information associated to the identifier associated to the target network node to configure uplink and/or downlink communications with the target network node.

The handover command may comprise a conditional handover command.

The determining may comprise: identifying that the identifier associated to the target network node has become activated by receiving spatial information and/or power control parameters associated to the identifier associated to the target network node.

The apparatus may be caused to: receive the spatial information and/or power control parameters associated to the identifier associated to the target network node via at least one of a downlink control information, and/or a Medium Access Control Control Element, and/or a configuration for sounding reference signal signalling.

The apparatus may be caused to: identify spatial information associated to the identifier associated to the target network node; and use said spatial information to configure uplink and/or downlink communications with the target network node. The apparatus may be caused to: receive, from at least one of the first and

target network nodes, a calculated timing advance configuration to apply to transmissions made to the target network node; and transmit to the target network node after applying the received calculated timing advance configuration.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a sixth aspect, there is provided a system, the system comprising: a user equipment according to any of the fifth aspect; the first network node; and the target network node, wherein each of the first and target network node comprises at least one respective processor, and at least one respective memory comprising code, wherein the respective code associated to the target network node, when run by the respective at least one processor of the target network node, causes the target transmission reception point to receive the random access channel signalling from the user equipment subsequent to the user equipment receiving said first information activating the identifier associated to the target network node; and wherein at least one of the first and target network nodes are caused to perform, via their respective stored code running on their respective processors: calculating a timing advance configuration to be applied by the user equipment to transmissions made by the user equipment to the target transmission reception point, and causing the calculated timing advance configuration to be signalled to the user equipment for altering a transmission time of transmissions made to the target transmission reception point.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a seventh aspect, there is provided an apparatus for a user equipment, the apparatus comprising: receiving circuitry for receiving, from a first network node, first information activating an identifier associated to the target network node; determining circuitry for determining to transmit random access channel signalling using a configuration corresponding to the identifier associated to the target network node; and transmitting circuitry for transmitting said random access channel signalling.

The determining circuitry for determining may comprise: monitoring circuitry for monitoring, for a first predetermined time period, for an instruction from the first and/or target network node to transmit random access channel signalling using the configuration corresponding to identifier associated to the target network node; and determining circuitry for, when no instruction is received during the first predetermined time period, determining to transmit said random access channel signalling using the configuration corresponding to the identifier associated to the target network node.

Said determining circuitry for determining may comprise: determining circuitry for determining, that uplink transmission timing for transmitting uplink transmission to the target network node is misaligned with respect to reception of uplink transmissions at the target network node; and determining circuitry for determining to transmit said random access channel signalling using the configuration corresponding to the identifier associated to the target network node in response to determining said misalignment.

Said determining circuitry for determining to transmit may be performed in response to determining that a timing alignment adjustment made by the user equipment cannot correct said misalignment.

Said receiving circuitry for receiving may comprise receiving circuitry for receiving a handover command, and the determining circuitry for determining may comprise: determining circuitry for determining to transmit said random access channel signalling using the configuration corresponding to the identifier associated to the target network node in response determining that the handover command relates to a different physical cell identifier to the physical cell identifier associated to the first network node.

The apparatus may comprise: receiving circuitry for receiving, from the target network node, a random access response to the random access channel signalling during a second predetermined time period; and using circuitry for using spatial information associated to the identifier associated to the target network node to configure uplink and/or downlink communications with the target network node in response to said received random access.

The apparatus may comprise: monitoring circuitry for monitoring for receipt of, from the target network node, a random access response to the random access channel signalling during a second predetermined time period; and using circuitry for, subsequent to the expiry of said second predetermined time period without the random access response being received, using spatial information associated to the identifier associated with the target network node to configure uplink and/or downlink communications to the target network node.

The handover command may comprise a conditional handover command.

The determining circuitry for determining may comprise: identifying circuitry for identifying that the identifier associated to the target network node has become activated by receiving spatial information and/or power control parameters associated to the identifier associated to the target network node.

The apparatus may comprise: receiving circuitry for receiving the spatial information and/or power control parameters associated to the identifier associated to the target network node via at least one of a downlink control information, and/or a Medium Access Control Control Element, and/or a configuration for sounding reference signal signalling.

The apparatus may comprise: identifying circuitry for identifying spatial information associated to the identifier associated to the target network node; and using circuitry for using said spatial information to configure uplink and/or downlink communications with the target network node.

The apparatus may comprise: receiving circuitry for receiving, from at least one of the first and target network nodes, a calculated timing advance configuration to apply to transmissions made to the target network node; and transmitting circuitry for transmitting to the target network node after applying the received calculated timing advance configuration.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to an eighth aspect, there is provided a system, the system comprising: a user equipment according to any of the seventh aspect; the first network node; and the target network node, wherein the target network node comprises receiving circuitry for receiving the random access channel signalling from the user equipment subsequent to the user equipment receiving said first information activating the identifier associated to the target network node, and at least one of the first and target network nodes comprises: calculating circuitry for calculating a timing advance configuration to be applied by the user equipment to transmissions made by the user equipment to the target transmission reception point, and at least one of the first and target network nodes comprises causing circuitry for causing the calculated timing advance configuration to be signalled to the user equipment for altering a transmission time of transmissions made to the target transmission reception point.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a ninth aspect, there is provided non-transitory computer readable medium comprising program instructions for causing an apparatus for a user equipment to perform: receive, from a first network node, first information activating an identifier associated to a target network node; determine to transmit random access channel signalling using a configuration corresponding to the identifier associated to the target network node; and transmit said random access channel signalling.

The determining may comprise: monitoring, for a first predetermined time period, for an instruction from the first and/or target network node to transmit random access channel signalling using the configuration corresponding to identifier associated to the target network node; and when no instruction is received during the first predetermined time period, determining to transmit said random access channel signalling using the configuration corresponding to the identifier associated to the target network node.

Said determining may comprise: determining, that uplink transmission timing for transmitting uplink transmission to the target network node is misaligned with respect to reception of uplink transmissions at the target network node; and determining to transmit said random access channel signalling using the configuration corresponding to the identifier associated to the target network node in response to determining said misalignment.

Said determining to transmit may be performed in response to determining that a timing alignment adjustment made by the user equipment cannot correct said misalignment.

Said receiving may comprise receiving a handover command, and the determining may comprise: determining to transmit said random access channel signalling using the configuration corresponding to the identifier associated to the target network node in response determining that the handover command relates to a different physical cell identifier to the physical cell identifier associated to the first network node.

The apparatus may be caused to: receive, from the target network node, a random access response to the random access channel signalling during a second predetermined time period; and use spatial information associated to the identifier associated to the target network node to configure uplink and/or downlink communications with the target network node in response to said received random access.

The apparatus may be caused to: monitor for receipt of, from the target network node, a random access response to the random access channel signalling during a second predetermined time period; and subsequent to the expiry of said second predetermined time period without the random access response being received, use spatial information associated to the identifier associated to the target network node to configure uplink and/or downlink communications with the target network node.

The handover command may comprise a conditional handover command.

The determining may comprise: identifying that the identifier associated to the target network node has become activated by receiving spatial information and/or power control parameters associated to the identifier associated to the target network node.

The apparatus may be caused to: receive the spatial information and/or power control parameters associated to the identifier associated to the target network node via at least one of a downlink control information, and/or a Medium Access Control Control Element, and/or a configuration for sounding reference signal signalling.

The apparatus may be caused to: identify spatial information associated to the identifier associated to the target network node; and use said spatial information to configure uplink and/or downlink communications to the target network node.

The apparatus may be caused to: receive, from at least one of the first and target network nodes, a calculated timing advance configuration to apply to transmissions made to the target network node; and transmit to the target network node after applying the received calculated timing advance configuration.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to a tenth aspect, there is provided a system, the system comprising: a user equipment according to any of the ninth aspect; the first network node; and the target network node, wherein there is provided respective non-transitory computer readable medium comprising program instructions for each of the target and first network nodes, wherein the respective non-transitory computer readable medium comprising program instructions associated to the target network node causes the target transmission reception point to receive the random access channel signalling from the user equipment subsequent to the user equipment receiving said first information activating the identifier associated to the target network node; and wherein the respective non-transitory computer readable medium comprising program instructions causes at least one of the first and target network nodes to perform: calculating a timing advance configuration to be applied by the user equipment to transmissions made by the user equipment to the target transmission reception point, and causing the calculated timing advance configuration to be signalled to the user equipment for altering a transmission time of transmissions made to the target transmission reception point.

The identifier associated to the target network node may comprise at least one of: a physical cell identity identifier, a Timing Advance Group identifier, a control resource set pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target network node; a sounding reference signal resource indicator; spatial related information update for a sounding reference signal resource indicator; and/or a transmission configuration indicator state.

The first network node may comprise at least one of the target network node or a different network node to the target network node.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

According to a fourteenth aspect, there is provided a method comprising: receiving, from a first network node, an indication indicative of transmission related information related to a second network node; determining to transmit random access channel, RACH signalling using a RACH configuration corresponding to the transmission related information associated to the second network node; and transmitting the RACH signalling to the second network node.

The transmission related information may comprise at least one of: spatial related information for at least one uplink channel transmission, power control parameter set information, an identifier of the second network node; a sounding reference signal resource indicator (SRI), spatial related information update for an SRI, or transmission configuration indicator (TCI) state.

The identifier of the second network node may comprise one of: a physical cell identifier, control resource set, CORESET, pool index, and transmission reception point identifier, TRP ID.

The at least one uplink channel transmission may comprise a transmission on a physical uplink shared channel and/or a transmission on a physical uplink control channel.

The method may further comprise: determining the identifier of the second network node is active based on the reception of the transmission related information.

The indication may be transmitted via a downlink control information (DCI), a medium access control control element (MAC CE), and/or a handover command message.

According to a fifteenth aspect, there is provided an apparatus comprising means for: receiving, from a first network node, an indication indicative of transmission related information related to a second network node; determining to transmit random access channel, RACH signalling using a RACH configuration corresponding to the transmission related information associated to the second network node; and transmitting the RACH signalling to the second network node.

The transmission related information may comprise at least one of: spatial related information for at least one uplink channel transmission, power control parameter set information, an identifier of the second network node; a sounding reference signal resource indicator (SRI), spatial related information update for an SRI, or transmission configuration indicator (TCI) state.

The identifier of the second network node may comprise one of: a physical cell identifier, control resource set, CORESET, pool index, and transmission reception point identifier, TRP ID.

The at least one uplink channel transmission may comprise a transmission on a physical uplink shared channel and/or a transmission on a physical uplink control channel.

The apparatus may further means for: determining the identifier of the second network node is active based on the reception of the transmission related information.

The indication may be transmitted via a downlink control information (DCI), a medium access control control element (MAC CE), and/or a handover command message.

According to a sixteenth aspect, there is provided an apparatus comprising: at least one processor; and at least one memory comprising code that, when executed by the at least one processor, causes the apparatus to: receive, from a first network node, an indication indicative of transmission related information related to a second network node; determine to transmit random access channel, RACH signalling using a RACH configuration corresponding to the transmission related information associated to the second network node; and transmit the RACH signalling to the second network node.

The transmission related information may comprise at least one of: spatial related information for at least one uplink channel transmission, power control parameter set information, an identifier of the second network node; a sounding reference signal resource indicator (SRI), spatial related information update for an SRI, or transmission configuration indicator (TCI) state.

The identifier of the second network node may comprise one of: a physical cell identifier, control resource set, CORESET, pool index, and transmission reception point identifier, TRP ID.

The at least one uplink channel transmission may comprise a transmission on a physical uplink shared channel and/or a transmission on a physical uplink control channel.

The apparatus may further be caused to: determine the identifier of the second network node is active based on the reception of the transmission related information.

The indication may be transmitted via a downlink control information (DCI), a medium access control control element (MAC CE), and/or a handover command message.

According to a seventeenth aspect, there is provided an apparatus comprising: receiving circuitry for receiving, from a first network node, an indication indicative of transmission related information related to a second network node; determining circuitry for determining to transmit random access channel, RACH signalling using a RACH configuration corresponding to the transmission related information associated to the second network node; and transmitting circuitry for transmitting the RACH signalling to the second network node.

The transmission related information may comprise at least one of: spatial related information for at least one uplink channel transmission, power control parameter set information, an identifier of the second network node; a sounding reference signal resource indicator (SRI), spatial related information update for an SRI, or transmission configuration indicator (TCI) state.

The identifier of the second network node may comprise one of: a physical cell identifier, control resource set, CORESET, pool index, and transmission reception point identifier, TRP ID.

The at least one uplink channel transmission may comprise a transmission on a physical uplink shared channel and/or a transmission on a physical uplink control channel.

The apparatus may further: determining circuitry for determining the identifier of the second network node is active based on the reception of the transmission related information.

The indication may be transmitted via a downlink control information (DCI), a medium access control control element (MAC CE), and/or a handover command message.

According to an eighteenth aspect, there is provided non-transitory computer readable medium comprising program instructions for causing an apparatus to perform: receive, from a first network node, an indication indicative of transmission related information related to a second network node; determine to transmit random access channel, RACH signalling using a RACH configuration corresponding to the transmission related information associated to the second network node; and transmit the RACH signalling to the second network node.

The transmission related information may comprise at least one of: spatial related information for at least one uplink channel transmission, power control parameter set information, an identifier of the second network node; a sounding reference signal resource indicator (SRI), spatial related information update for an SRI, or transmission configuration indicator (TCI) state.

The identifier of the second network node may comprise one of: a physical cell identifier, control resource set, CORESET, pool index, and transmission reception point identifier, TRP ID.

The at least one uplink channel transmission may comprise a transmission on a physical uplink shared channel and/or a transmission on a physical uplink control channel.

The apparatus may further be caused to: determine the identifier of the second network node is active based on the reception of the transmission related information.

The indication may be transmitted via a downlink control information (DCI), a medium access control control element (MAC CE), and/or a handover command message.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIG. 6 illustrates Timing Advance;

FIG. 7 illustrates example signalling between entities described herein;

FIG. 8 illustrates example operations that may be performed by a user equipment described herein; and

FIGS. 9 and 10 illustrate example operations that may be performed by apparatus described herein.

### DETAILED DESCRIPTION

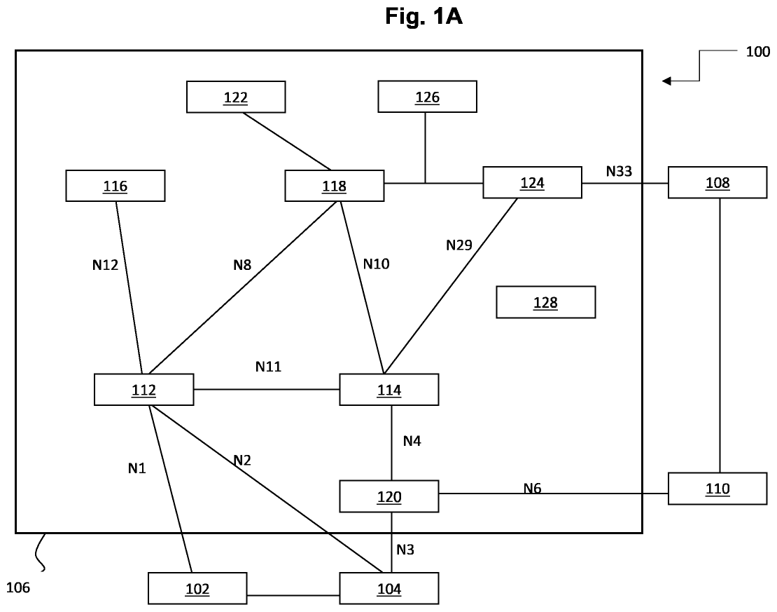

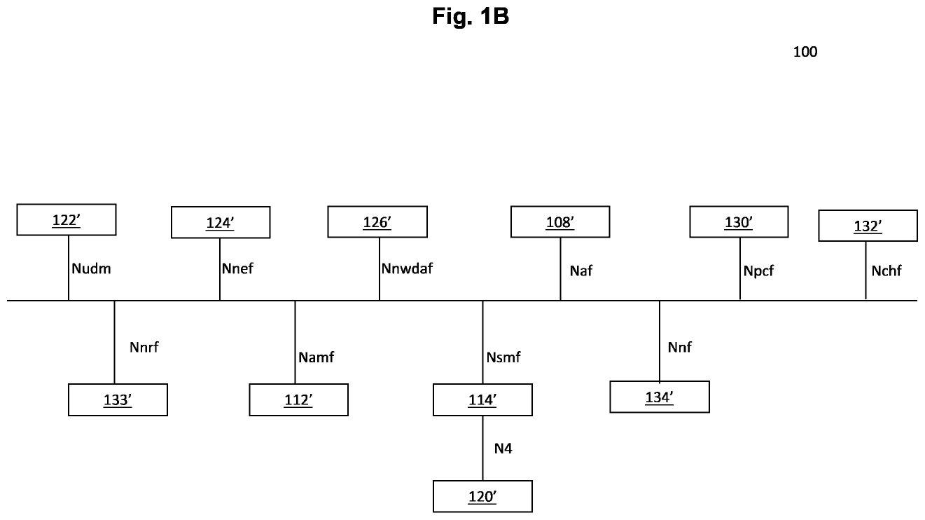

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representation of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

The concept and functionality of NR Timing Advance is same as the LTE Timing Advance. Simply put, Timing Advance is a special command (notification) from a transmission/reception point (e.g., an access point such as an eNB/gNB) to a UE that configures the UE to adjust its uplink transmission (uplink frame) with respect to a downlink reception timing (downlink frame). This kind of uplink adjustment applies to any of a variety of uplink channels, such as, for example, the physical uplink shared channel (PUSCH), the physical uplink control channel (PUCCH), and Sounding Reference Signals (SRS). As an aside, SRS are uplink-only, UE-specific signals that are transmitted by UEs to help an access point obtain the channel state information (CSI) for each user.

In general, Timing Advance is a mechanism used (normally via a Medium Access Control (MAC) control element) that is used to control uplink signal transmission timing. An access point continuously measures a time difference between PUSCH/PUCCH/SRS reception and a subframe time at the access point, and can send a ‘Timing Advance’ command to UE to change the uplink transmission timing to make it better aligned with the subframe timing at the network side. When a PUSCH/PUCCH/SRS transmission timer arrives at the network too early, the access point sends a Timing Advance command to the UE to instruct the UE to send its uplink signals a little bit later. When a PUSCH/PUCCH/SRS transmission timer arrives at the network too late, the access point sends a Timing Advance command to the UE to instruct the UE to send its uplink signals a little bit earlier. Timing advance is illustrated with respect to FIG. 6.

FIG. 6 illustrates a downlink frame 601 whose reception is offset from the start of transmission of an uplink frame 602 by a time T. This time T may be written as:

T=(N_{TA}+N_{TAOffset})T_{c}

N_{TA} represents a Timing advance value received from the network (e.g., via a Medium Access Control (MAC) Control Element (CE) and/or via Random Access Response (RAR) signalling). N_{TA} may be defined in a plurality of different ways. For example, a MAC CE Timing Advance value may be defined as:

N_{TA-New}=N_{TA-Old}+(T_{A}−31)*16.64/2^{M}(where T_{A}=0,1,2, . . . ,63)

As another example, a RAR Timing Advance value may be defined as:

N_{TA}=T_{A}*16.64/2^{μ}(where T_{A}=0,1,2, . . . ,3846)

T_{c} is a predefined timing unit (T_{c}=0.509 ns in current specifications).

N_{TAOffset} is identified by the UE based on information received from a network, or according to a default value (where the network has not provided a specific value). This default value may be dependent on the frequency range (e.g., FR1 or FR2) currently being used, as well as whether the uplink transmission is made using frequency division duplex (FDD) or time division duplex (TDD) techniques, and whether the transmission is being made with or without LTE-NR coexistence. These default values are illustrated below with respect to Table 1.

TABLE 1
Example default N_{TAOffet}

| Frequency range and band of cell | N_{TAOffset} value |
|---|---|
| used for uplink transmission | (unit: T_{c}) |
| FR1 FDD band without LTE-NR coexistence case | 25600 |
| FR1 TDD band without LTE-NR coexistence case | |
| FR1 FDD band with LTE-NR coexistence case | 0 |
| FR1 TDD band with LTE-NR coexistence case | 39936 |
| FR2 | 13792 |

This kind of uplink timing advance adjustment applies to a plurality of different channels, such as a physical uplink shared channel (PUSCH), a physical uplink control channel (PUCCH), and a sounding reference signal (SRS).

As mentioned above, Timing Advance information can be provided to a UE through Random Access Response (RAR) signalling or via MAC CE signalling.

When RAR signalling is used, a UE calculates a timing advance value to be used from information comprised in two different MAC layer commands. For the first Uplink message after Physical Random Access Channel (PRACH) signalling, the UE applies the Timing Advance value that it extracts from received RAR signalling. After the initial RACH process, the UE may apply the timing Advance value that it extracts from a Timing Advance MAC CE if received.

When MAC CE signalling is used, the UE adjusts UL transmission based on the MAC CE-Timing Advance received after an initial attach procedure is performed. The Timing Advance Command Field is 6 bits, which mean 64 Timing Advance steps can be signalled in total, ranging from −32 to 32 T_{c} in real timing. Since T_{c} is 0.509 according to current specifications, the range of the physical timing for MAC CE-based Timing Advance is −16.3 μs to 16.3 μs with 15 kHz subcarrier spacing.

A timing advance group comprises a set of one or more serving cells with the same uplink Timing Advance and same downlink timing reference cell. Each Timing advance group comprises at least one serving cell with configured uplink, and the mapping of each serving cell to a Timing advance group is configured by Radio Resource Control (RRC) signalling. 3GPP TS 38.321 defines a timing advance group as a group of Serving Cells that is configured by RRC and that, for the cells with an uplink configured, using the same timing reference cell and the same Timing Advance value. A Timing advance group comprising the Secondary Primary Cell (SpCell) of a MAC entity is referred to as Primary Timing advance group (PTiming advance group), whereas the term Secondary Timing advance group (STiming advance group) refers to other Timing advance groups.

Rel-17 introduced and specified the use of intercell Multi-transmission-reception-point (Multi-TRP) operation within a 3GPP network.

Multi-TRP is a feature that enables access points, such as gNBs, to use more than one TRP to communicate with a UE. There are a couple of different ways for this type of communication to be performed.

For example, a first TRP and a second TRP may transmit data using respective different Physical Downlink Shared Channels (PDSCHs) to a UE, while control signal for the two PDSCH is transmitted by only the first TRP (e.g., via a Physical Downlink Control Channel (PDCCH transmission or via downlink control information (DCI) transmissions). In this case, if there is some problem over the radio link between the UE and the first TRP such that the PDCCH reception fails, the communication of the UE via the second TRP is impacted as well.

As another example, a first TRP and a second TRP may transmit data using respective different Physical Downlink Shared Channels (PDSCHs) to a UE while also transmitting their own respective control information for these PDSCHs (e.g., via respective PDCCH transmissions or DCI transmissions. In this case, if there is any problem in radio link with one of the TRPs, the communication via other TRP can remain intact.

As a third example, the first and second TRPs are jointly used to process downlink and uplink signals (similar scenario to coordinated multipoint (COMP) transmission).

Under the Multi-TRP definition provided by Rel-17, a Transmission Configuration Indicator (TCI) state may be associated with, or otherwise correspond to either one or two physical cell identities (PCIs).

A PCI is an identifier used to identify a cell during cell selection procedure. According to current definitions (which may be subject to change), a PCI has a value dependent on the combination of that cell's Primary Synchronization Signal (PSS) and that cell's Secondary Synchronization Signal (SSS).

A TCI state is dynamically sent to a UE from a network. The TCI state may be signalled using a Downlink Control Information (DCI) message that comprises configurations such as quasi-co-located-relationships between the downlink reference signals in one Channel State Indicator Reference Signal (CSI-RS) set and the PDSCH Demodulation reference signal ports. Two antenna ports are said to be quasi-co-located when properties of the channel over which a symbol on one antenna port is conveyed can be inferred from the channel over which a symbol on the other antenna port is conveyed. Therefore, indicating a TCI state to a UE may indicate a quasi-co-location relationship to the UE between a demodulation reference signal of the PDSCH and at least one downlink reference signal.

Rel-17 agreed that, for inter-cell Multi-TRP, one PCI associated with one or more of activated TCI states for Physical Downlink shared Channel/Physical Downlink Control Channel (PDSCH/PDCCH) will be associated with one set of resources (e.g., with one CORESETPoolIndex), and another PCI associated with one or more of activated TCI states for PDSCH/PDCCH will be associated with another set of resources (e.g. with another CORESETPoolIndex). An activated TCI state may be considered a TCI state that is comprised in a limited subset of the total number of TCI states (i.e., less than all of the possible TCI states), the limited subset being configured by a Medium Access Control control element command for a given channel, and/or signal, and/or transmission. CORESETPoolIndex is an index of a CORESET pool for a corresponding CORESET. A CORESET refers to a Control Resource Set, and refers to a set of resources. For example, in the frequency domain, a CORESET is a set of contiguous or distributed physical resource blocks (PRBs), while in the time domain, a CORESET is a set of contiguous Orthogonal Frequency Division Multiplex (OFDMA) symbols.

The association between PCI and CORESETPoolIndex when switching between intra-cell multi-TRP and inter-cell multi-TRP was determined to be for future study.

Rel-18 introduced a number of objectives in relation to multiple-input-multiple-output (MIMO) enhancements, including the use of two Timing Advances for signalling in uplink multi-DCI for use in multi-TRP

Some of these objectives are as follows.

First, it was agreed to extend Rel-17 Unified TCI framework for indication of multiple downlink and uplink TCI states focusing on multi-TRP use case, using the Rel-17 TCI framework described above.

Second, it was agreed to investigate the use of larger number of orthogonal DMRS ports for downlink and uplink multi-user-MIMO (without increasing the Demodulation Reference Signal (DM-RS) overhead) for Cyclic Prefix (CP)-OFDM transmissions. This investigation would consider both aiming for a common design between downlink and uplink DMRS transmissions, and/or the use of up to 24 orthogonal DM-RS ports, where for each applicable DMRS type, the maximum number of orthogonal ports is doubled for both single- and double-symbol DMRS

Third, it was agreed to investigate uplink DMRS, SRS, and SRS resource indicator (SRI), and precoding information (including codebook) enhancements to enable up to 8 transmitter uplink operation to support 4 and more layers per UE in uplink targeting a range of different application scenarios (e.g., vehicle/Industrial devices, etc.).

Fourth, it was agreed to investigate simultaneous multi-panel uplink transmission for higher uplink throughput/reliability, focusing on Frequency Range 2 (FR2) and multi-TRP, assuming up to 2 TRPs and up to 2 panels, targeting a range of different application scenarios (e.g., vehicle/Industrial devices, etc.).

This investigation would include investigating an uplink precoding indication for use on the PUSCH, where no new codebook is introduced for multi-panel simultaneous transmission, and where the total number of layers is up to four across all panels and total number of codewords is up to two across all panels, considering single DCI and multi-DCI based multi-TRP operation.

This investigation would further include the use of an uplink beam indication for transmissions over the PUCCH and/or PUSCH, considering single DCI and multi-DCI based multi-TRP operation. For the case of multi-DCI based multi-TRP operation, only PUSCH+PUSCH, or PUCCH+PUCCH is transmitted across two panels in a same component carrier (CC).

Fifth, an investigation may be performed for considering the use of two Timing Advances for uplink multi-DCI for multi-TRP operation, and to consider power control for uplink single DCI for multi-TRP operation.

The general support of two Timing Advance enhancement has been agreed for both intra-cell and inter-cell multi-DCI multi-TRP scenarios in Rel-18 and beyond. The following relates to addressing problems that may arise when looking to support the use of of two Timing Advance enhancements for both intra-cell and inter-cell multi-DCI multi-TRP scenarios. In other words, the following relates to addressing issues arising with respect to the above-mentioned fifth objective.

The following aims to address issues associated with acquiring/determining the Timing Advance for an intercell multi-TRP without necessarily increasing current levels of downlink control overhead.

As mentioned above, Rel-17 specified intercell M-TRP operation. According to this definition, a TCI state may be associated with a PCI, and at most two PCIs are associated to activated TCI states. It should be noted that the serving cell's associated PCI may not be explicitly associated to TCI states, and only an additional PCI, i.e., a PCI other than serving cell PCI, may be explicitly associated to TCI states. The explicit association of this additional PCI may be performed through, for example, synchronisation signals (e.g., synchronisation signal block(s) (SSB(s)) and/or CSI-RS(s)) associated to the additional PCI.

To address at least one of the above-mentioned issues, the following discloses a mechanism under which a UE autonomously sends a RACH (or PRACH) transmission based on a preconfigured random-access configuration. A network-based entity (e.g., a serving TRP and/or the target TRP and/or a controller thereof) may subsequently use receipt of such a random access channel transmission at the target TRP to calculate a timing advance configuration for the UE in respect of transmissions to the target TRP. This timing advance configuration may be provided back to the UE, which can then apply the calculated timing advance configuration in respect of subsequent transmissions from UE to the target TRP.

As the random access channel transmission made by the UE is made autonomously, the UE does not receive a trigger from the network that is specifically for causing the random access channel transmission to be performed, which reduces the amount of overhead signalling in the network compared to cases when an explicit instruction is received.

The preconfigured random-access configurations may be, for example contention based random access (CBRA), and/or contention free random access (CFRA).

The RACH/PRACH transmission may be sent for a cell/TRP having a given PCI (that is different to the PCI of the UE's serving cell) when the given PCI gets activated. The UE may then use the pre-configured random-access configuration, such as RACH occasions and/or preambles and/or PUSCH occasions (for 2-step RACH), corresponding to the activated PCI for the RACH transmission(s).

More details on when the UE may perform the autonomous signalling is provided below. However, in general, a UE may perform the autonomous signalling in response to determining that a cell/TRP that is associated with a different PCI to the PCI associated with the serving cell/TRP of the UE has been activated.

The UE may determine whether a PCI is activated in any of a plurality of different ways. These are discussed further below.

The UE may consider a PCI as active or activated when the UE determines that at least one of the following information has been signalled to the UE.
An activation or indication in a MAC control element of spatial relation information for at least one PUCCH resource, where this spatial relation information indicates a reference signal (RS) associated with the PCI being considered. The association may be signalled to the UE using higher layer signalling (i.e., above MAC layer signalling). In current specifications, spatial relation information is indicated using the “PUCCH-SpatialRelationInfo” control element.
An activation or indication in a MAC control element of power control parameter set information for at least one PUCCH resource, where this power control parameter set information is associated with the PCI being considered. The power control information sets a power for the UE transmitting an uplink signal. The association may be signalled to the UE using higher layer signalling (i.e., above MAC layer signalling).
An indication of a spatial relation information update for an SRI, e.g., via MAC control element, where this spatial relation information is associated with the PCI being considered. The association may be signalled to the UE using higher layer signalling (i.e., above MAC layer signalling).
An indication comprised in downlink control information (DCI) of the SRI of the PUSCH for which the spatial relation information or quasi-colocation information is associated with the PCI being considered.
An indication of spatial relation information for an SRS, where this spatial relation information is associated with the PCI being considered. The association may be signalled to the UE using higher layer signalling (i.e., above MAC layer signalling).
An indication of a MAC CE and/or Downlink Control Information activating and/or indicating at least one TCI state for downlink and/or uplink channels/signals where this at least one TCI state indicates quasi-co-location information comprising a reference signal associated with the PCI being considered. The association may be signalled to the UE using higher layer signalling (i.e., above MAC layer signalling).

In an example application, when the cell associated with the PCI being considered represents or is configured with multiple TRPs (e.g., multiple TRPs share the same given PCI), the UE may autonomously send a RACH transmission based on a random-access configuration that corresponds to the considered PCI and a TCI state, TRP identity (such as, for example, a CORESETpoolIndex or a TRP ID), or other representation of a different uplink link/transmission when that PCI and TCI state/TRP identity/or a different uplink transmission gets activated (or indicated) to the UE. The association of a CORESETPoolIndex and/or TRP ID to a PCI state may be configured using higher layer signalling (e.g., via RRC configuration signalling/signalling above the MAC-layer).

In another example application, the RACH transmission towards a different Cell/TRP may be triggered by the reception of a PDCCH signal received from the (newly) activated PCI (e.g., PDCCH order from activated PCI or indicating that PCI).

In such a case, the UE may, when the UE has not received a PDCCH (or PDCCH order) from the activated PCI within a pre-defined/pre-configured time duration (e.g., time after the PCI is activated), send a RACH transmission based on a random-access configuration which is corresponding to the activated PCI.

Further, when the UE receives a PDCCH (or PDCCH order) from the activated PCI within a pre-defined/pre-configured time duration (e.g., time after the PCI is activated), the UE may send a RACH transmission based on the indicated/pre-configured random-access configuration that corresponds to the activated PCI.

The above-mentioned time duration may be configured or specified with respect to a reference point/time, such as, for example, the first or last symbol of an uplink transmission (such as, for example, a transmission on the Physical Uplink Control Channel (PUCCH) or a transmission on the Physical Uplink Shared Channel (PUSCH)) or downlink reception (such as, for example, a transmission on the Physical Downlink Control Channel (PDCCH) or a transmission on the Physical Downlink Shared Channel (PDSCH)).

For example, the reference point/time may be the last symbol of the PUCCH that is transmitted in response to the PDSCH carrying a MAC CE activating the PCI. As another example, the reference point/time may be the last symbol of the PUCCH that is transmitted in response to the PDCCH carrying downlink control information activating the PCI.

In an example, a Random Access Channel (RACH) transmission towards (or corresponding to) a different Cell/TRP may be triggered by the reception of a handover command that is associated with a given PCI other than the serving cell PCI. When such a handover command is received, the UE may send a RACH transmission based on a random-access configuration that corresponds to the given PCI.

When the UE receives a RACH response (or a positive RACH response) from the network (e.g., a Random Access Respond (RAR) from the different Cell/TRP), the UE may consider the RACH response as being a PCI activation command for enabling the UE to receive PDCCH/PDSCH and/or transmit PUCCH/PUSCH/SRS using the TCI states associated with the given PCI. In other words, the UE may consider the RACH response as indicating that TCI state(s) associated with the given PCI may be considered activated/indicated.

When the UE does not receive a random-access response (or doesn't correctly receive the random-access response (RAR) from the network), the UE may still receive PDCCH/PDSCH and transmit PUCCH/PUSCH using the TCI states associated with the given PCI after a pre-defined/pre-configured time duration. The time duration may be configured or specified with respect to a reference point/time such as the first or last symbol of a RACH transmission.

In the case of a conditional handover (CHO) handover, the RACH transmission towards (or corresponding to) a different Cell/TRP may be triggered by a conditional handover triggered by the UE that is associated with or otherwise corresponds to a given PCI other than the PCI associated with the serving cell. When such a conditional handover event occurs, the UE may send a RACH transmission to a target cell that is based on a random-access configuration that corresponds to the given PCI.

The UE may be configured to use and/or apply one or more of the above operation(s) by signalling from the network. For example, the UE may be configured to use and/or apply one or more of the above operations by RRC signalling from the network.

The presently described mechanisms may be used by the network to acquire/determine/calculate an updated Timing Advance of a TRP in a cell with the activated PCI.

These example operations are illustrated in more detail below.

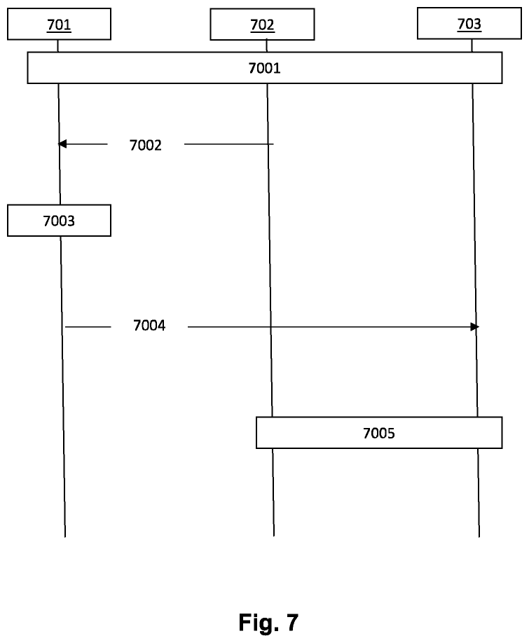

FIG. 7 illustrates example signalling that may be performed between entities described herein.

FIG. 7 illustrates signalling that may be performed between a UE 701, a first transmission/reception point TRP1 702, and a second transmission/reception point TRP2 703. The first transmission/reception point 702 is associated with a first PCI, PCI1. The second transmission/reception point 703 is associated with a second PCI, PCI2. In other words, the first and second transmission/reception points 702, 703 belong to different physical cells.

During 7001, the network (e.g., the first TRP, AP or gNB) configures the UE with a random-access configuration for the second PCI. This random-access configuration may comprise RACH resources and/or RACH preambles (and/or even PUSCH occasions) for the second PCI. The random-access configuration may be performed using RRC signalling. The random-access configuration may be performed using an entity located within an access point/gNB. For example, the random-access configuration may be signalled to the UE 701 from a central unit. The entity that configures the UE with the random-access configuration may be at least one of the first transmission/reception point, the second transmission/reception point, and/or a controller of at least one of the first and/or second transmission/reception points.

During 7002, the first transmission/reception point 702 signals the UE 701. This signalling may comprise an indication of at least one TCI state. In the present example, the indication of at least one TCI state comprises an indication of a TCI state correspond to the second PCI. The indicated TCI state(s) provide quasi-co-location information comprising a reference signal correspond to or otherwise associated with the second PCI. The quasi-co-location information may be inferred using previously received signalling from the network that provides such an association. This association information is currently provided via higher layer signalling (i.e., above MAC layer) in Rel-17.

The indication may comprise an instruction activating the indicated at least one TCI state.

The signalling of 7002 may be performed in any number of ways. For example, the signalling of 7002 may be effected by the first transmission/reception point 702 sending a MAC control element. As another example, the signalling of 7002 may be effected by the first transmission/reception point 702 sending downlink control information. The MAC control element and/or the downlink control information may be signalled using a physical downlink channel such as, for example, a PDSCH or PDCCH.

During 7003, the UE 701 determines, based on the received signalling of 7002, that the second PCI is activated. For example, the UE 701 may determine, based on the received MAC CE/DCI and specifically on the indicated TCI state, that the second PCI is newly activated. This is because the TCI state is associated with or otherwise corresponds to the second PCI.

In response to this determination of 7003, the UE then decides/determines to transmit over the random access channel using the random-access configuration for the second PCI.

Therefore, during 7004, the UE 701 signals a RACH preamble (or PRACH) using the random-access configuration for the second PCI. This signalling of 7004 is subsequently received by the second transmission/reception point 703.

During 7005, the first and/or second transmission/reception points (or some other network entity controlling at least one of these first and/or second transmission/reception points (not shown)) use the received RACH transmission of 7004 to determine a Timing Advance corresponding to the second transmission/reception point 703 and/or second PCI.

For example, the second TRP 703 may calculate the Timing Advance associated with the second PCI based on RACH reception. The details of how this is done at the TRP is explained hereinafter.

As one example, the second TRP 703 may determine a time difference between the time at which the RACH transmission of 7004 was received and a downlink transmission timing used by the TRP. This determined time difference may be later used to calculate a one-way propagation delay from the UE 701 to the second TRP 703. The calculation may be provided by any network entity such as, for example, the first TRP 702, the second TRP 703, and/or any controller thereof, when that network entity is provided with the determined time difference. The calculated one-way propagation delay may be used when determining an uplink timing shift. For example, the uplink timing shift may be twice the propagation delay. The uplink timing shift indicates a timing offset that the UE 701 should apply to in order for the second TRP 703 to receive uplink transmissions from the UE 701 in a desired uplink reception timing at the second TRP 703. The uplink timing shift may correspond to the timing advance indicated towards the UE 701.

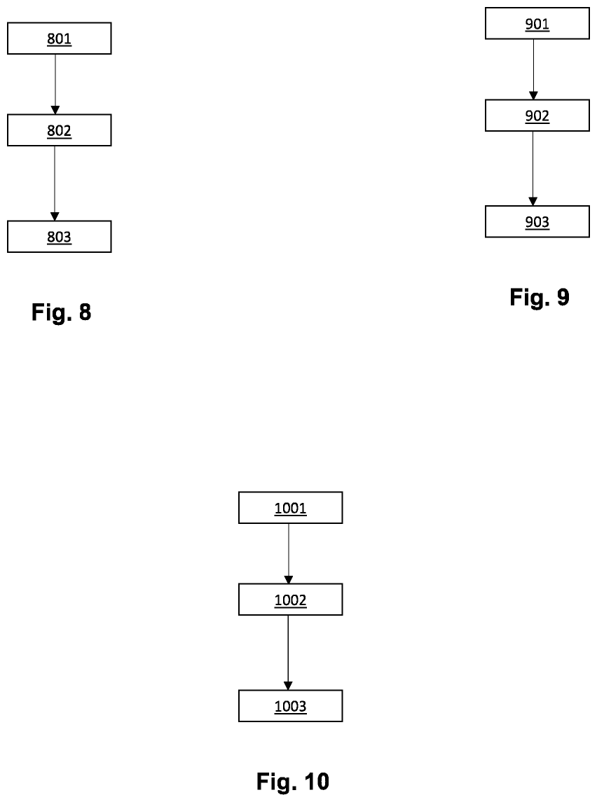

FIG. 8 illustrates some additional features of the presently described mechanism, from the point of view of the UE (such as, for example, the UE 701 of FIG. 7).

During 801, the UE determines that a given PCI is activated. This may be, for example, as a result of the signalling of 7002.

During 802, the UE determines that the UE has not received a PDCCH order triggering the UE to make a RACH transmission corresponding to the given PCI withing a preconfigured time period of determining that the given PCI is activated.

During 803, in response to the determination of 802, the UE makes a RACH transmission using a RACH configuration that corresponds to the given PCI. This transmission may be as per 7004.

FIGS. 9 and 10 illustrates aspects of the above examples. It is therefore understood that features described above may find correspondence below. Further, it is understood that the above-described examples may provide additional features for understanding, and without limiting, how the presently described examples may be implemented.

Further, although the following refers to “transmission-reception points”, these entities may simply be considered as network nodes. A network node may comprise an access point, TRP, and gNB, etc. to a network. A network node may comprise a controller of an access point to a network.

FIG. 9 illustrates operations that may be performed by a user equipment.

During 901, the user equipment receives, from at least one of a first transmission-reception point and a target transmission-reception point, first information activating an identifier associated to the target transmission-reception point. The first transmission-reception point may comprise a serving transmission-reception point of the user equipment, or a non-serving transmission-reception point of the user equipment. The phrase “associated to” may be used herein to indicate that a configured association exists between two entities. For example, when an identifier is associated to the target transmission-reception point, there exists a configured association that associated the identifier to the target transmission-reception point. Alternatively, the phrase “associated to” may not necessarily mean that there is an (explicit) association configured. For example, when an identifier is associated to the target transmission-reception point (or network node), then this identifier is essentially used to represent the target transmission-reception point (or network node).

The identifier may have previously been configured at the UE. For example, the identifier may have previously been configured at the UE using RRC signalling. The identifier may have previously been configured at the UE as part of a set of identifiers for identifying target TRP. The first information activating the identifier may be received via MAC and/or physical layer signaling. The first information activating the identifier may be received via a MAC control element and/or via downlink control information signalling.

During 902, the UE autonomously determines to transmit random access channel signalling using a configuration corresponding to the identifier associated to the target transmission-reception point. In the present context, the term “autonomously” comprises the UE perform an action (i.e. determining to transmit) without an explicit instruction to do so from the network (e.g., the first TRP and/or the target TRP).

During 903, the UE transmits said random access channel signalling.

The autonomously determining may comprise: monitoring, for a first predetermined time period, for an instruction from the first and/or target transmission-reception point to transmit random access channel signalling using the configuration corresponding to identifier associated to the target transmission-reception point; and when no instruction is received during the first predetermined time period, determining to transmit said random access channel signalling using the configuration corresponding to the identifier associated to the target transmission-reception point.

The autonomously determining may comprise: determining that uplink transmission timing for transmitting uplink transmission to the target transmission-reception point is misaligned with respect to reception of uplink transmissions at the target transmission-reception point; and determining to transmit said random access channel signalling using the configuration corresponding to the identifier associated to the target transmission-reception point in response to determining said misalignment.

Said determining to transmit may be performed in response to determining that an autonomous timing alignment adjustment by the user equipment cannot correct said misalignment. For example, in response to detecting the misalignment, the UE may apply a timing adjustment to the timing of uplink transmissions to the first TRP in order to correct the misalignment without receiving explicit instruction from the network to make such an adjustment. The determining to transmit may be performed in response to subsequently determining that this adjustment has not corrected the misalignment enough for uplink transmission to the first TRP to be successful. As another example, the UE may determine that the misalignment is relatively large, e.g., larger than a threshold, in which case the UE may determine that an autonomous timing alignment adjustment cannot correct this misalignment. The UE may then decide to transmit RACH signaling in this case. On the other side, the UE may determine that the misalignment is relatively small, e.g., lower than (or equal to) a threshold, in which case the UE may determine that an autonomous timing alignment adjustment can correct this misalignment. The UE may then decide to not transmit RACH signaling in this case.

Said receiving may comprise a handover command, and the autonomously determining may comprise: determining to transmit said random access channel signalling using the configuration corresponding to the identifier associated to the target transmission-reception point in response determining that the handover command relates to a different physical cell identifier to the physical cell identifier associated to the first transmission-reception point.

The user equipment may further: receive, from the target transmission-reception point, a random access response to the random access channel signalling during a second predetermined time period; and use spatial information associated to the identifier associated to the target transmission-reception point to configure uplink and/or downlink communications with the target transmission-reception point in response to said received random access. This spatial information may comprise at least one of: TCI state or spatial relation or SRS resource indicator or SRS resource(s) or power control parameter set.

The UE may: monitor for receipt of, from the target transmission-reception point, a random access response to the random access channel signalling during a second predetermined time period; and subsequent to the expiry of said second predetermined time period without the random access response being received, using spatial information associated to the identifier associated to the target transmission-reception point to configure uplink and/or downlink communications with the target transmission-reception point.

The handover command may comprise a conditional handover command.

The autonomously determining may comprise: identifying that the identifier associated to the target transmission-reception point has become activated by receiving spatial information and/or power control parameters associated to the identifier associated to the target transmission-reception point.

The UE may receive the spatial information and/or power control parameters associated to the identifier associated to the target transmission-reception point via at least one of a downlink control information, and/or a Medium Access Control Control Element, and/or a configuration for sounding reference signal signalling.

The user equipment may: identify spatial information associated to the identifier associated to the target transmission-reception point; and use said spatial information to configure uplink and/or downlink communications with the target transmission-reception point. The spatial information may have been previously configured at the UE using higher layer signalling. For example, the spatial information may have previously been configured at the UE using RRC signalling.

The user equipment may: receive, from at least one of the first and target transmission-reception points, a calculated timing advance configuration to apply to transmissions made to the target transmission-reception point; and transmit to the target transmission-reception point after applying the received calculated timing advance configuration. The timing advance configuration may have been calculated using the transmitted random access signalling of 903.

FIG. 10 illustrates features of a system comprising a user equipment according to FIG. 9, the first TRP mentioned in respect of FIG. 9, and the target TRP mentioned in respect of FIG. 9.

During 1001, the target transmission-reception point receives the random access channel signalling from the user equipment subsequent to the user equipment receiving said first information activating the identifier associated to the target transmission-reception point.

During 1002, at least one of the first and target transmission-reception points calculates a timing advance configuration to be applied by the user equipment to transmissions made by the user equipment to the target transmission reception point.

During 1003, the at least one of the first and target transmission-reception points causes the calculated timing advance configuration to be signalled to the user equipment for altering a transmission time of transmissions made to the target transmission reception point. Although not shown in FIG. 10, the user equipment may use the received calculated timing advance configuration to adjust an uplink timing of transmissions to the target TRP.

In all of the above examples of FIGS. 9 and 10, the identifier associated to the target transmission-reception point may comprise at least one of: a physical cell identity identifier, a Timing Advance Group identifier, a control resource (coreset) pool index, a Transmission-Reception Point Identifier, at least one Transmission Configuration Indicator state, at least one spatial relation identifier, and/or at least one power control parameter set configuration.

The first information may comprise at least one of: spatial related information for at least one uplink channel or transmission; a power control parameter set information; an identifier of the target TRP; a sounding reference signal resource indicator; spatial related information update for a sounding reference signal resource indicator; and/or a transmission configuration indicator state.

Although the present mechanisms are described in the context of handover, the present mechanisms may be applied to any operation involving the UE and two distinct transmission/reception points. For example, the presently described mechanisms may also be configured in respect of carrier aggregation (CA). In other words, the presently described operations may be configured/applicable per component carrier (or a group of components carriers).

It is further understood that references throughout to “RACH” transmissions also cover PRACH transmission. For example, a preamble transmission in case of a 4-step RACH and a preamble and PUSCH transmission in case of a 2-step RACH. The term “RACH transmission” may also refer to any subsequent message transmitted by the UE to the second transmission/reception point after making the determination that the second PCI is active. For example, using current terminology, Msg3 (PUSCH) or PUCCH transmissions corresponding to Msg4 may be used for the signalling of 7004.

The above-described mechanism provides a technique for acquiring/determining Timing Advance for a newly activated cell or PCI in case of intercell multi-TRP that does not increase downlink control signalling overhead compared to current signalling mechanisms.

It is understood that the terms “activated” and “active” are used synonymously in the above.

Further, although the examples above have focused on PCI, it is understood that the presently described techniques may also be applied in respect of the UE detecting other identifiers that correspond to (or are otherwise associated to) a TRP. The identifier associated to a TRP may comprise one or more of the following: a PCI, a Timing Advance Group (TAG) identifier, an index to a set of control resources, a Transmission-Reception Point Identifier, at least one Transmission Configuration Indicator state, at least one spatial relation identifier, and/or at least one power control parameter set configuration.

For example, a TAG may be considered as active if at least one TCI state or spatial relation information or power control parameter set associated to this TAG is activated or otherwise indicated to the UE. This may be indicated to the UE via, for example, a MAC control element and/or via downlink control information.

Further, when a TAG is activated, the UE may determine to autonomously transmit RACH using a RACH configuration corresponding to this TAG, in a similar way to as proposed above when the UE detects that a PCI for a TRP is active.

As another example, when a new TCI state(s) is updated/indicated to the UE, indication this may trigger the UE to autonomously transmit RACH using a RACH configuration that corresponds to this TCI state(s) in a similar way to as proposed above when the UE detects that a PCI for a TRP is active.

As yet another example, a set of TCI states may be configured, and when at least one of these TCI states is indicated to the UE as being activated, this may trigger the UE to autonomously transmit RACH using a RACH configuration that corresponds to this set of TCI states in a similar way to as proposed above when the UE detects that a PCI for a TRP is active.

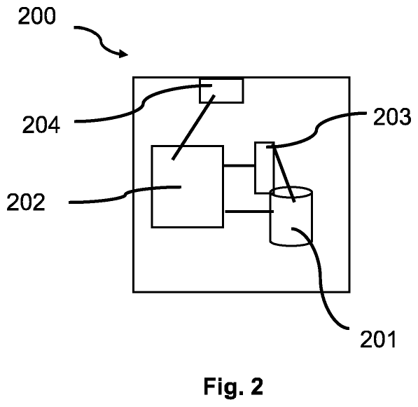

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

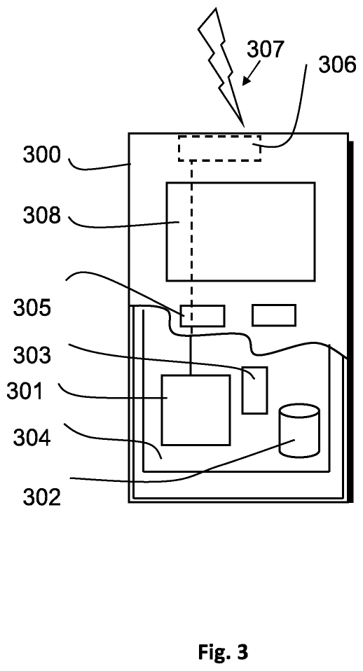

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or′ wireless) to other devices and/or for connecting external accessories, for example hands-free equipment, thereto.

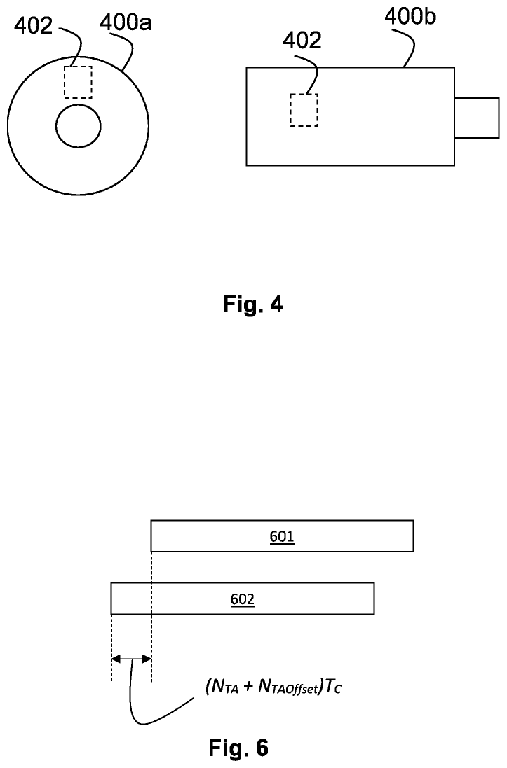

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9, and/or FIG. 10, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 9, and/or FIG. 10, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

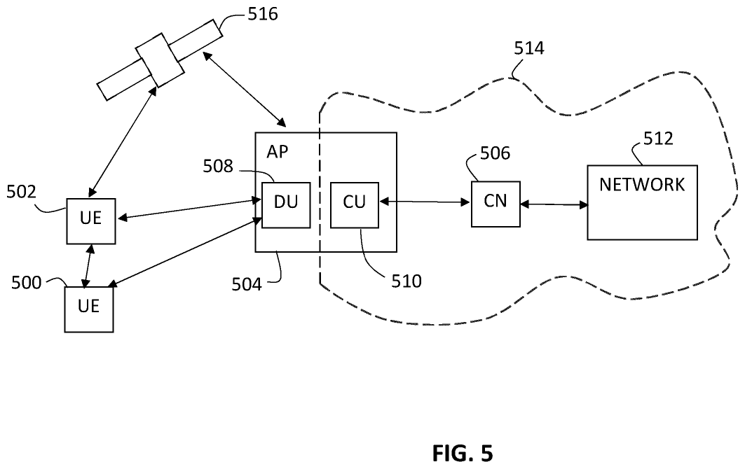

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IOT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells.

1-19. (canceled)

20. An apparatus comprising:
at least one processor; and
at least one memory storing instructions that, when executed by the at least one processor, cause the apparatus at least to perform:
receiving, from a first network node, first information activating an identifier associated to a target network node;
determining to transmit random access channel signalling using a configuration corresponding to the identifier associated to the target network node; and
transmitting the random access channel signalling.

21. The apparatus as claimed in claim 20, wherein the determining comprises:
monitoring, for a first predetermined time period, for an instruction from the first network node and/or target network node to transmit random access channel signalling using the configuration corresponding to the identifier; and
when no instruction is received during the first predetermined time period, determining to transmit the random access channel signalling using the configuration corresponding to the identifier.

22. The apparatus as claimed in claim 20, wherein the determining comprises:
determining that uplink transmission timing for transmitting uplink transmission to the target network node is misaligned with respect to reception of uplink transmissions at the target network node; and
determining to transmit the random access channel signalling using the configuration corresponding to the identifier node in response to determining the misalignment.

23. The apparatus as claimed in claim 22, wherein the determining to transmit is performed in response to determining that a timing alignment adjustment made by the apparatus cannot correct the misalignment.

24. The apparatus as claimed in claim 20, wherein the receiving comprises a handover command, and the determining comprises:
determining to transmit said random access channel signalling using the configuration corresponding to the identifier in response determining that the handover command relates to a different physical cell identifier to a physical cell identifier associated with the first network node.

25. The apparatus as claimed in claim 24, wherein the apparatus is further caused to perform:
receiving, from the target network node, a random access response to the random access channel signalling during a second predetermined time period; and
using spatial information associated with the identifier to configure uplink and/or downlink communications with the target network node in response to the received random access.

26. The apparatus as claimed in claim 24, wherein the apparatus is further caused to perform:
monitoring for receipt of, from the target network node, a random access response to the random access channel signalling during a second predetermined time period; and
subsequent to the expiry of the second predetermined time period without the random access response being received, using spatial information associated with the identifier to configure uplink and/or downlink communications with the target network node.

27. The apparatus as claimed in claim 20, wherein the determining comprises:
identifying that the identifier associated to the target network node has become activated by receiving spatial information and/or power control parameters associated to the identifier associated to the target network node.

28. A method for an apparatus, the method comprising:
receiving, from a first network node, first information activating an identifier associated to a target network node;
determining to transmit random access channel signalling using a configuration corresponding to the identifier associated to the target network node; and
transmitting the random access channel signalling.

29. The method as claimed in claim 28, wherein the determining comprises:
monitoring, for a first predetermined time period, for an instruction from the first network node and/or target network node to transmit random access channel signalling using the configuration corresponding to the identifier; and
when no instruction is received during the first predetermined time period, determining to transmit the random access channel signalling using the configuration corresponding to the identifier.

30. The method as claimed in claim 28, wherein the determining comprises:
determining that uplink transmission timing for transmitting uplink transmission to the target network node is misaligned with respect to reception of uplink transmissions at the target network node; and
determining to transmit the random access channel signalling using the configuration corresponding to the identifier node in response to determining the misalignment.

31. The method as claimed in claim 30, wherein the determining to transmit is performed in response to determining that a timing alignment adjustment made by the apparatus cannot correct the misalignment.

32. The method as claimed in claim 28, wherein the receiving comprises a handover command, and the determining comprises:
determining to transmit said random access channel signalling using the configuration corresponding to the identifier in response determining that the handover command relates to a different physical cell identifier to a physical cell identifier associated with the first network node.

33. The method as claimed in claim 32, the method comprising:
receiving, from the target network node, a random access response to the random access channel signalling during a second predetermined time period; and
using spatial information associated with the identifier to configure uplink and/or downlink communications with the target network node in response to the received random access.

34. The method as claimed in claim 32, the method comprising:
monitoring for receipt of, from the target network node, a random access response to the random access channel signalling during a second predetermined time period; and
subsequent to the expiry of the second predetermined time period without the random access response being received, using spatial information associated with the identifier to configure uplink and/or downlink communications with the target network node.

35. The method as claimed in claim 28, wherein the determining comprises:
identifying that the identifier associated to the target network node has become activated by receiving spatial information and/or power control parameters associated to the identifier associated to the target network node.

36. A non-transitory computer readable medium comprising instructions which, when executed by an apparatus, cause the apparatus to perform:
receiving, from a first network node, first information activating an identifier associated to a target network node;
determining to transmit random access channel signalling using a configuration corresponding to the identifier associated to the target network node; and
transmitting the random access channel signalling.

37. The non-transitory computer readable medium as claimed in claim 36, wherein the determining comprises:
monitoring, for a first predetermined time period, for an instruction from the first network node and/or target network node to transmit random access channel signalling using the configuration corresponding to the identifier; and
when no instruction is received during the first predetermined time period, determining to transmit the random access channel signalling using the configuration corresponding to the identifier.

38. The non-transitory computer readable medium as claimed in claim 36, wherein the determining comprises:
determining that uplink transmission timing for transmitting uplink transmission to the target network node is misaligned with respect to reception of uplink transmissions at the target network node; and
determining to transmit the random access channel signalling using the configuration corresponding to the identifier node in response to determining the misalignment.

39. The non-transitory computer readable medium as claimed in claim 38, wherein the determining to transmit is performed in response to determining that a timing alignment adjustment made by the apparatus cannot correct the misalignment.
